(19) United States
(12) Patent Application Publication
(10) Pub. No.: US 2013/0073667 A1
(43) Pub. Date: Mar. 21, 2013

(54) TECHNIQUES FOR ADMINISTERING AND MONITORING MULTI-TENANT STORAGE

(71) Applicants: Umasankar Mukkara, Bangalore (IN); Felix Xavier, Bangalore (IN); Ratna Kiran Mova, Bangalore (IN)

(72) Inventors: Umasankar Mukkara, Bangalore (IN); Felix Xavier, Bangalore (IN); Ratna Kiran Mova, Bangalore (IN)

(73) Assignee: CLOUDBYTE, INC., SAN MATEO, CA (US)

(21) Appl. No.: 13/616,846

(22) Filed: Sep. 14, 2012

(30) Foreign Application Priority Data
Sep. 20, 2011 (IN) 3236/CHE/2011

(51) Int. Cl. G06F 15/167

(52) U.S. Cl. 709/213

(57) ABSTRACT

Techniques for managing and monitoring multi-tenant storage in a cloud environment are presented. Storage resources are monitored on a per tenant bases and as a whole for the cloud environment. New and existing administrative types can be dynamically created and managed within the cloud environment.

### RELATED APPLICATIONS

The present application is co-pending with and claims foreign priority to Indian Provisional Patent Application No. 3236/CHE/2011 entitled: “Method and Architecture to Manage and Monitor Multi-Tenant Storage in Cloud Storage Environment,” filed with the Indian Patent Office on Sep. 20, 2011, the disclosure of which is incorporated by reference herein in its entirety.

### BACKGROUND

Cloud computing is rapidly changing the Internet into a collection of clouds, which provide a variety of computing resources, storage resources, and, in the future, a variety of resources that are currently unimagined.

Specifically, cloud computing is a technology infrastructure that facilitates: supplementing, consuming, and delivering Information Technology (IT) services. The cloud environment provides elastic provisioning of dynamically scalable virtual services.

A tenant is considered as a subscriber of some amount of storage in the cloud or an application who owns part of the shared storage environment. Multi-tenancy is an architecture where a single instance of software runs on a server, which is serving multiple tenants. In a multi-tenant environment, all tenants and their users consume the service from a same technology platform, sharing all components in the technology stack including the data model, servers, and database layers. Further, in a multi-tenant architecture, the data and configuration is virtually partitioned and each tenant works with a customized virtual application instance.

Current technologies allow an administrator to have a monolithic view of the administration of a storage controller with respect to the storage and storage controller resources.

Moreover, exiting technologies within a shared storage environment may allow limited control for administering tenant-based storage. The limitations of these current technologies are the following:
1) the tenant administrator is be able to control user level authentication parameters for storage services of the tenant;
2) the tenant administrator is not be able to provision storage to various needs of the tenant organization within the permitted boundaries;
3) the tenant administrator is not be able to monitor how much of the storage controller resources are being used by a particular tenant—the resources include Central Processing Unit (CPU), memory, hard disk utilization, and network throughout; and
4) a Cloud Service Provider administrator is not able to see storage controller resource utilization on a per tenant basis.

### SUMMARY

Various embodiments of the invention provide techniques for administering and monitoring multi-tenant storage in a cloud storage environment. Specifically, and in one embodiment a method for managing multi-tenant storage in a cloud environment is presented.

More particularly and in an embodiment, each tenant operating within a cloud storage environment is identified by a Tenant Storage Machine (TSM) for that tenant. Next, a utilization for resources of the cloud storage environment is acquired on a per tenant bases via each tenant's TSM. Finally, utilization views are presented for the cloud storage environment as a whole and for each tenant to a display of an administrator.

### BRIEF DESCRIPTION OF THE DRAWINGS

FIG. 1A is a diagram depicting an administrator's view of multi-tenant storage in a cloud storage environment, according to embodiments presented herein.

FIG. 1B is a diagram depicting a process for delegating administration of storage in a cloud storage environment using quotas, according to embodiments presented herein.

FIG. 1C is a diagram depicting a global administrator's view of storage control resources in a cloud storage environment, according to embodiments presented herein.

FIG. 1D is a diagram depicting a tenant administrator's view of storage control resources in a cloud storage environment, according to embodiments presented herein.

FIG. 1E is a diagram of a table depicting creation of new administrative types in a multi-tenant storage environment of a cloud storage environment, according to embodiments presented herein.

FIG. 2 is a diagram of a method for managing multi-tenant storage in a cloud storage environment, according to embodiments presented herein.

FIG. 3 is a diagram of another method for managing multi-tenant storage in a cloud storage environment, according to embodiments presented herein.

FIG. 4 is a diagram of a multi-tenant storage management system, according to embodiments presented herein.

### DETAILED DESCRIPTION

A “resource” includes a user, service, system, device, directory, data store, groups of users, a file, a file system, combinations and/or collections of these things, etc. A “principal” is a specific type of resource, such as an automated service or user that acquires an identity. As used herein a “principal” may be used synonymously and interchangeably with the term “tenant.”

A “processing environment” defines a set of cooperating computing resources, such as machines (processor and memory-enabled devices), storage, software libraries, software systems, etc. that form a logical computing infrastructure. A “logical computing infrastructure” means that computing resources can be geographically distributed across a network, such as the Internet. So, one computing resource at network site X and be logically combined with another computing resource at network site Y to form a logical processing environment.

The phrases “processing environment,” “cloud processing environment,” “cloud environment,” and the term “cloud” may be used interchangeably and synonymously herein.

Moreover, it is noted that a “cloud” refers to a logical and/or physical processing environment as discussed above.

The techniques presented herein are implemented in machines, such as processor or processor-enabled devices (hardware processors). These machines are configured and programmed to specifically perform the processing of the methods and systems presented herein. Moreover, the methods and systems are implemented and reside within a non-transitory computer-readable storage media or machine-readable storage medium and are processed on the machines configured to perform the methods.

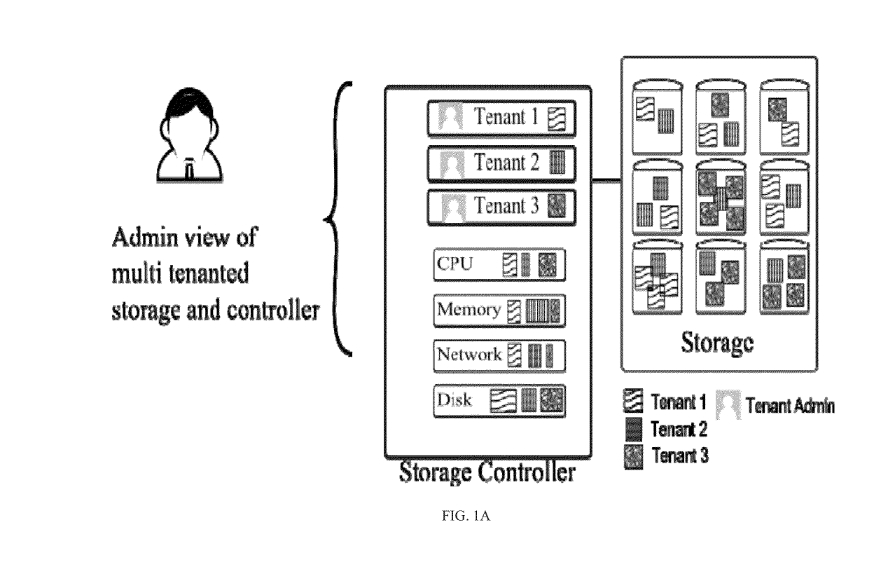

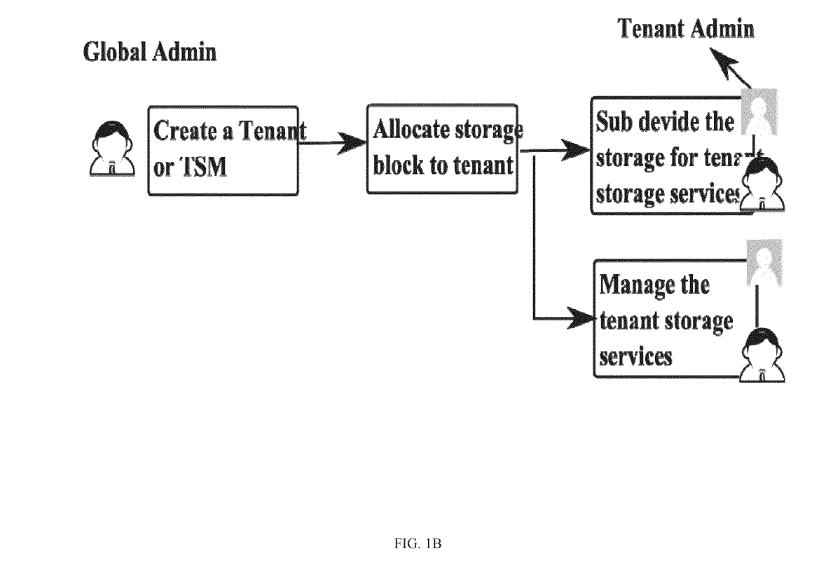

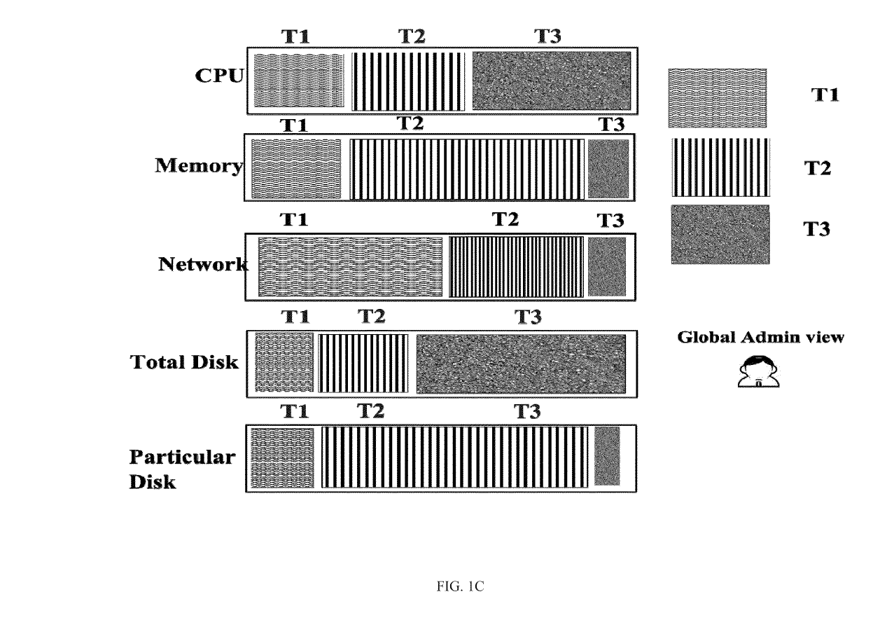

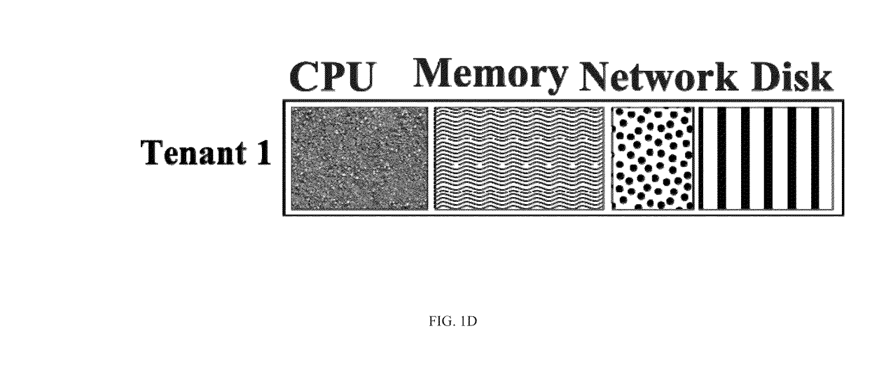

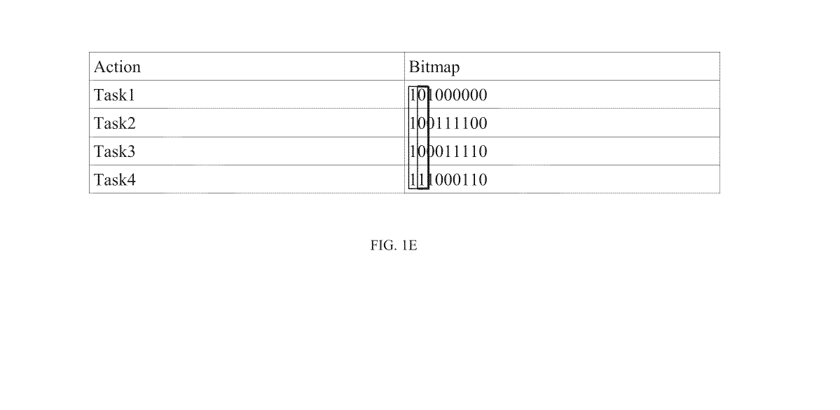

It is within this context that embodiments of the invention are now discussed within the context of the FIGS. 1-4.

FIG. 1A is a diagram depicting an administrator's view of multi-tenant storage in a cloud storage environment, according to embodiments presented herein. It is noted that the architecture is presented as one example embodiment as other arrangements and elements are possible without departing from the teachings presented herein.

As shown in the FIG. 1A, the storage controller has a granular view of the resources and the storage on a per tenant basis. This is achieved by limiting all the storage services of a tenant to a Tenant Storage Machine (TSM) container.

This specific technique gives the concept of managing and monitoring resources on a per tenant basis from the perspective of the global administrator.

FIG. 1B is a diagram depicting a process for delegating administration of storage in a cloud storage environment using quotas, according to embodiments presented herein.

As shown in the FIG. 1B, the global administrator consolidates and manages the top level storage. A block or chunk of storage is allocated to each tenant. Once a TSM or tenant is created, the sub-quota management and storage services management is done by the tenant administrator or the global administrator.

FIG. 1C is a diagram depicting a global administrator's view of storage control resources in a cloud storage environment, according to embodiments presented herein.

FIG. 1D is a diagram depicting a tenant administrator's view of storage control resources in a cloud storage environment, according to embodiments presented herein.

The techniques presented herein help the storage tenants to verify if the services they bought are in line with what they see on the monitoring screen of the storage controller. A tenant can confront a service provider indicating that the resources of the controller used by him/her are much less and probably could be a reason for less performance on the storage services.

FIG. 1E is a diagram of a table depicting creation of new administrative types in a multi-tenant storage environment of a cloud storage environment, according to embodiments presented herein.

The techniques prescribe a mechanism in which new types of administrators can be added by the main administrators and configured with actions that can be performed by those types of administrators. This technique involves maintaining a table (see FIG. 1E) in which each row corresponds to an action that can be performed by the administrators as shown in the FIG. 1E.

The bitmap is a variable length field in which the number of digits indicates the number of administrator types. The actions allowed by an administrator of type 1 is arrived at by combining the first digits in the FIG. 1E. For example, from the FIG. 1E table, it can be inferred that, the administrator of type 1 is allowed to perform Tasks 1,2,3,4 and the administrator of type 2 is allowed to perform only task 4.

It can also be observed that as new types of administrators are added to the administration console, more digits can be added to bitmap. This technique allows for the expansion of the types of administrators very easily.

The techniques presented herein above and below provide for the following beneficial arrangements:
1) permitting the tenant administrator to do the entire storage administration for any particular tenant;
2) permitting the global admin to view the storage controller resource usage (CPU, memory, network, disk) on a per tenant disk usage and on a per tenant basis;
3) permitting the global admin to view the percentage of a particular disk usage on a per tenant basis
4) permitting the tenant to monitor exactly the amount of storage being used by the tenant;
5) permitting the tenant to monitor the storage controller resource usage by the tenant;
6) techniques for setting quotas for each tenant by the global administrator or the storage controller administrator and providing the independence to create and manage sub-quotas for storage needs of multiple applications within the tenant;
7) consolidating the storage into a very big pool for the management at an organization level and giving the flexibility of storage administration and monitoring at a tenant level; and
8) the technique in which new types of administrators are added dynamically to the administration console without having to change the code and rebuild the product.

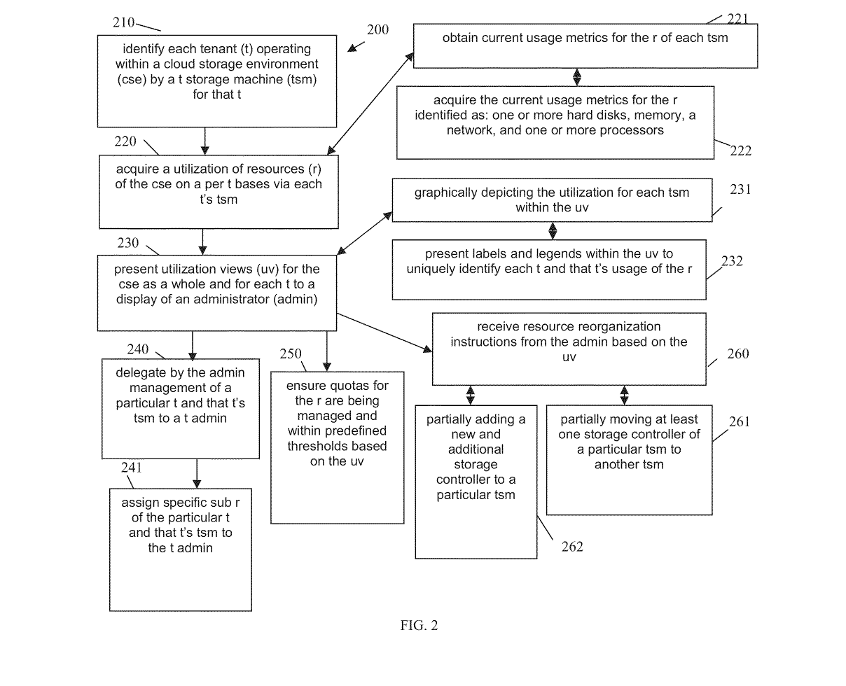

FIG. 2 is a diagram of a method 200 for managing multi-tenant storage in a cloud storage environment. The method 200 (herein referred to as “storage manager”) is implemented, programmed, and resides within a non-transitory machine-readable storage medium that executes on one or more processors of a network. The network may be wired, wireless, or a combination of wired and wireless.

In an embodiment, the storage manager is deployed and utilizes the approaches presented above with respect to the FIGS. 1A-1E.

At the outset it is noted that a Tenant Storage Machine (TSM) is akin to a Virtual Machine (VM) that is dynamically instantiated when a tenant requests storage on the cloud storage environment. This TSM permits novel control and isolation of the tenant and its services and storages to that of other tenants operating within the cloud storage environment.

At 210, the storage manager identifies each tenant operating within a cloud storage environment by a TSM for that tenant. Again, there is a one-to-one or one-to-many mapping for between each tenant and each TSM. So, a tenant has a single TSM or multiple TSMs but no two tenants share a same TSM.

At 220, the storage manager acquires a utilization of resources of the cloud storage environment on a per tenant bases via each tenant's TSM. The utilization may be viewed as metrics for each tenant and each resource available within the cloud storage environment.

According to an embodiment, at 221, the storage manager obtains current usage metrics for the resources of each TSM.

Continuing with the embodiment of 221 and at 222, the storage manager acquires the current usage metrics for the resources identified as: one or more hard disks, memory, a network, and one or more processors (identified as CPUs above in FIGS. 1A, 1C, and 1D).

At 230, the storage manager presents utilization views for the cloud storage environment as a whole and for each tenant onto a display of an administrator. Some of the utilization views were presented above as examples in the FIGS. 1A, 1C, and 1D.

In an embodiment, at 231, the storage manager graphically depicts the utilization for each TSM within the utilization views. This is shown in the FIGS. 1A, 1C, and 1D where the tenant and the TSM can be used interchangeably.

Continuing with the embodiment of 231 and at 232, the storage manager presents labels and legends within the utilization views to uniquely identify each tenant and that tenant's usage of the resources. See, as an example, the FIGS. 1A and 1C.

According to an embodiment at 240, the storage manager delegates, via the administrator (which may be viewed as a global cloud storage environment administrator), the management of a particular tenant and that tenant's TSM; the delegation made to a tenant administrator.

Continuing with the embodiment of 240 and at 241, the storage manager assigns a specific sub resource of the particular tenant and that tenant's TSM to the tenant administrator for management. So, delegation can happen at the sub resource level and does not have to just be at the whole TSM level.

In an embodiment, at 250, the storage manager ensures that quotas for the resources are being managed within predefined threshold values based on the utilization views. In other words, checks can be made to ensure the service level agreements with the tenants are being properly honored with the resources and performance of the resources within the cloud storage environment.

In another case, at 260, the storage manager receives resource reorganization instructions from the administrator based on the utilization views. In other words, the administrator is actively managing the cloud storage environment and its multiple tenants and the resources based on the granular details of the utilization views.

Continuing with the embodiment at 260 and at 261, the storage manager partially moves at least one storage controller of a particular TSM to another TSM. This can occur when one tenant is under using and another tenant is over using storage resources based on the utilization views.

Still continuing with the embodiment of 260 and at 262, the storage manager partially adds a new and additional storage controller to a particular TSM. This occurs when a tenant is expanding storage or reaching a max on the allocated storage controllers in anticipation of the tenant upgrading to more storage.

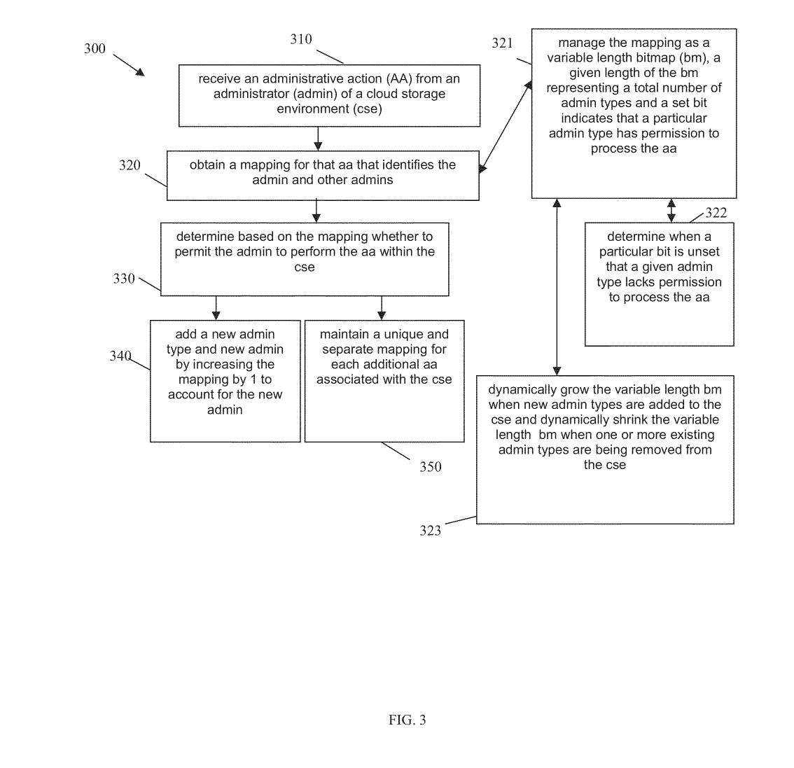

FIG. 3 is a diagram of another method 300 for managing multi-tenant storage in a cloud storage environment, according to embodiments presented herein. The method 300 (herein referred to as “administrator manager”) is implemented, programmed, and resides within a non-transitory machine-readable storage medium that executes on one or more processors of a network. The network may be wired, wireless, or a combination of wired and wireless.

The administrator manager presents an enhanced perspective of the storage manager represented by the method 200 of the FIG. 2. Moreover, the administrator manager is implemented or deployed within the approaches shown in the FIGS. 1A-1E (more particularly FIG. 1E).

At 310, the administrator manager receives an administrative action from an administrator of a cloud storage environment. That is, a particular administrator within the cloud storage environment is attempting to process an administrative action. This is trapped and processed in the following manners before the action is permitted to proceed.

At 320, the administrator manager obtains a mapping for the administrative action that identifies the administrator and other administrators of the cloud storage environment.

According to an embodiment, at 321, the administrator manager manages the mapping as a variable length bitmap. A given length of the bitmap represents a total number of administrator types. Also, a set bit in the bitmap represents that a particular administrator type has permissions to process the administrative action. So, each bit represents a type of administrator. When administrators authenticate to the cloud storage environment, they are assigned a role and that role comports with the administrator type and that type is represented as a specific bit at a specific location within the bitmap (bit string).

Continuing with the embodiment of 321 and at 322, the administrator manager determines when a particular bit is unset that a given administrator type lacks permission to process the administrative action.

Still continuing with the embodiment of 321 and at 323, the administrator manager dynamically grows the variable length bitmap when new administrator types are added to the cloud storage environment. Moreover, the administrator manager dynamically shrinks the variable length bitmap when one or more existing administrator types are being removed from the cloud storage environment.

At 330, the administrator manager determines based on the mapping whether to permit the administrator to perform the administrative action within the cloud storage environment. An example of how this is achieved was presented above with the processing associated with 321-323 and the FIG. 1E.

According to an embodiment, at 340, the administrator manager adds a new administrator type and new administrator by increasing the mapping by one to account for the new administrator.

In another case, at 350, the administrator manager maintains a unique and separate mapping for each additional administrative action associated with the cloud storage environment. This situation was illustrated and discussed above with reference to the FIG. 1E.

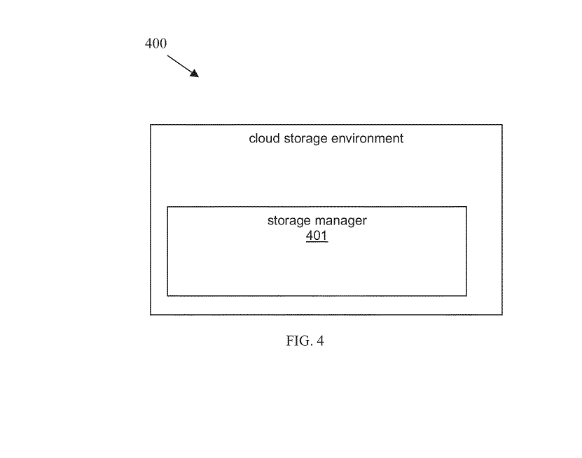

FIG. 4 is a diagram of a multi-tenant storage management system 400, according to embodiments presented herein. The components of the multi-tenant storage management system 400 are implemented, programmed, and reside within a non-transitory machine-readable storage medium that executes on one or more processors of a network. The network may be wired, wireless, or a combination of wired and wireless.

In an embodiment, the multi-tenant storage management system 400 implements, inter alia, the processing associated with the methods 200 and 300 of the FIGS. 2 and 3, respectively using the approaches provided by the FIGS. 1A-1E.

The tenant data confidentiality system 400 includes a cloud storage environment having a key manager 401.

The multi-tenant storage management system 400 includes a cloud storage environment that has one or more processors, memory, and storage.

The memory of the cloud storage environment is configured with the storage manager 501, which is implemented as executable instructions that process on one or more processors of the cloud storage environment. Example processing associated with the storage manager 501 was presented above in detail with reference to the FIGS. 1A-1E, 2, and 3.

The storage manager 501 is configured to obtain usage metrics for resources of the cloud storage environment as a whole and on a per tenant basis using a TSM. Moreover, the storage manager 501 is also configured to present utilization views for the usage metrics to an administrator for managing and monitoring the cloud storage environment.

According to an embodiment, the TSM is a VM and processing environment established dynamically for a particular tenant.

In an embodiment, at least one utilization view includes a legend or labels and identifies the usage metrics for each tenant in a single view for the administrator. This was presented above with the FIGS. 1A and 1C.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method implemented in a non-transitory machine-readable storage medium and processed by one or more processors of a machine configured to perform the method, comprising:
identifying, from the machine, each tenant operating within a cloud storage environment by a Tenant Storage Machine (TSM) for that tenant;
acquiring, from the machine, a utilization for resources of the cloud storage environment on a per tenant bases via each tenant's TSM;
presenting, from the machine, utilization views for the cloud storage environment as a whole and for each tenant to a display of an administrator.

2. The method of claim 1 further comprising, delegating, via the machine and by the administrator, management of a particular tenant and that tenant's TSM to a tenant administrator.

3. The method of claim 2, wherein delegating further includes assigning specific sub resources of the particular tenant and that tenant's TSM to the tenant administrator.

4. The method of claim 1 further comprising, ensuring, via the machine, quotas for the resources are being managed and within predefined thresholds based on the utilization views.

5. The method of claim 1 further comprising, receiving resource reorganization instructions from the administrator based on the utilization views.

6. The method of claim 5, wherein receiving further includes partially moving at least one storage controller of a particular TSM to another TSM.

7. The method of claim 5, wherein receiving further includes partially adding a new and additional storage controller to a particular TSM.

8. The method of claim 1, wherein acquiring further includes obtaining current usage metrics for the resources of each TSM.

9. The method of claim 1, wherein obtaining further includes acquiring the current usage metrics for the resources identified as: one or more hard disks, memory, a network, and one or more processors.

10. The method of claim 9, wherein presenting further includes graphically depicting the utilization for each TSM within the utilization views.

11. The method of claim 10, wherein graphically depicting further includes presenting labels and legends within the utilization views to unique identify each tenant and that tenant's usage of the resources.

12. A method implemented in a non-transitory machine-readable storage medium and processed by one or more processors of a machine configured to perform the method, comprising.
receiving, on the machine, an administrative action from an administrator of a cloud storage environment;
obtaining, on the machine, a mapping for that administrative action that identifies the administrator and other administrators; and
determining, on the machine, based on the mapping whether to permit the administrator to perform the administrative action within the cloud storage environment.

13. The method of claim 12 further comprising, adding, on the machine, a new administrator type and new administrator by increasing the mapping by one to account for the new administrator.

14. The method of claim 12 further comprising, maintaining, on the machine, a unique and separate mapping for each additional administrative action associated with the cloud storage environment.

15. The method of claim 12, wherein obtaining further includes managing the mapping as a variable length bit map, a given length of the bit map representing at total number of administrator types and a set bit indicates that a particular administrator type has permission to process the administrative action.

16. The method of claim 15, wherein managing further includes determining when a particular bit is unset that a given administrator type lacks permission to process the administrative action.

17. The method of claim 15, wherein managing further includes dynamically growing the variable length bitmap when new administrator types are added to the cloud storage environment and dynamically shrinking the variable length bitmap when one or more existing administrator types are being removed from the cloud storage environment.

18. A system, comprising:
a cloud storage environment having one or more processors, memory, and storage, the cloud storage environment situated in a cloud environment and accessed over a network; and
the memory configured with a storage manager implemented as executable instructions that process on the one or more processors of the cloud storage environment;
wherein the storage manager is configured to obtain usage metrics for resources of the cloud storage environment as a whole and on a per tenant basis using a Tenant Storage Machine (TSM), and the storage manager configured to present utilization views for the usage metrics to an administrator for managing and monitoring the cloud storage environment.

19. The system of claim 18, wherein the TSM is a Virtual Machine and processing environment established dynamically for a particular tenant.

20. The system of claim 18, wherein at least one utilization view includes a legend or labels and identifies the usage metrics for each tenant in a single view for the administrator.
